(19) United States
(12) Patent Application Publication
(10) Pub. No.: US 2023/0009136 A1
(43) Pub. Date: Jan. 12, 2023

(54) AXIAL FLUX MACHINE COMPRISING A STATOR HAVING RADIALLY EXTENDING SHEET METAL SEGMENTS

(71) Applicant: Schaeffler Technologies AG & Co. KG, Herzogenaurach (DE)

(72) Inventor: Holger Witt, Bühl (DE)

(73) Assignee: Schaeffler Technologies AG & Co. KG, Herzogenaurach (DE)

(21) Appl. No.: 17/782,256

(22) PCT Filed: Nov. 3, 2020
(86) PCT No.: PCT/DE2020/100936

§ 371 Date: Jun. 3, 2022

(30) Foreign Application Priority Data
Dec. 4, 2019 (DE) 10 2019 133 020.3
Jan. 20, 2020 (DE) 10 2020 101 148.2

(51) Int. Cl. H02K 21/24; H02K 1/14; H02K 16/02; H02K 1/18

(52) U.S. Cl. CPC H02K 21/24; H02K 1/14; H02K 16/02; H02K 1/182

(57) ABSTRACT

An axial flux machine for a drive train of a purely electric or hybrid motor vehicle having an annular stator and two rotor elements which are mounted so as to be rotatable relative to the stator about a rotational axis. A first rotor element is arranged axially adjacent to a first end face of the stator and a second rotor element is arranged axially adjacent to a second end face of the stator. The stator has a plurality of stator cores that are distributed in a circumferential direction of a circular line extending about the axis of rotation and are designed in a wedge shape in the radial direction. At least one stator core has a plurality of radially extending sheet metal segments that are stacked on top of one another in the circumferential direction and are of plate-like design. All of the sheet metal segments (are surrounded on their two circumferential sides, that face away from one another in the circumferential direction, by a covering section made of a soft-magnetic composite material.

### CROSS-REFERENCE TO RELATED APPLICATIONS

This application is the U.S. National Phase of PCT Appln. No. PCT/DE2020/100936 filed Nov. 3, 2020, which claims priority to DE 10 2019 133 020.3 filed Dec. 4, 2019 and DE 10 2020 101 148.2 filed Jan. 20, 2020, the entire disclosures of which are incorporated by reference herein.

### TECHNICAL FIELD

The disclosure relates to an axial flux machine, preferably for a drive train of a purely electric or hybrid motor vehicle, said axial flux machine comprising an annular stator and two rotor elements which are mounted so as to be rotatable relative to the stator about a (common) rotational axis, wherein a first rotor element is arranged axially (along the rotational axis) adjacent to a first (axial) end face of the stator and a second rotor element is arranged axially adjacent to a second (axial) end face of the stator, and wherein the stator has a plurality of stator cores (preferably designed in a wedge shape in the radial direction) that are distributed in a circumferential direction of a circular line extending about the axis of rotation.

### BACKGROUND

Generic axial flux machines are already well known from the prior art. For example, WO 2018/015293 A1 discloses a stator for an axial flux machine having a stator portion formed of a plurality of sheets and provided with teeth.

Further prior art is known, for example, from WO 2014/166811 A2, which discloses a lightweight axial flux machine in which a plurality of stator teeth are connected to one another in end regions via a respective ring structure and to a housing surrounding the stator radially on the outside. Consequently, it is already known to construct stator cores by means of sheets which are arranged laterally to the stator cores in the axial direction.

However, it has been shown to be a disadvantage of these designs known from the prior art that the existing magnetic resistance in the required directions is often still relatively large. Furthermore, eddy currents form in the magnetic core (in an increased capacity in the edge regions), which are caused by the alternating currents in the windings as well as by the magnetic fields from the rotor. Furthermore, in some cases, the mechanical strength is relatively low.

### SUMMARY

It is therefore the object of the present disclosure to remedy the disadvantages known from the prior art and, in particular, to provide an axial flux machine with a stator core that is as stable as possible, wherein at the same time the magnetic resistance is reduced in the required directions and undesirable eddy currents are avoided.

According to the disclosure, this is achieved in that at least one stator core has a plurality of radially extending sheet metal segments that are stacked on top of one another in the circumferential direction and are of plate-like design, wherein all of the sheet metal segments are surrounded on their two circumferential sides, that face away from one another in the circumferential direction, by a covering section made of a soft-magnetic composite material.

This results in several advantages. The side covering sections reduce eddy currents. The central sheet metal segments ensure a high magnetic flux density in the axial direction due to the low magnetic resistance in the axial direction. Due to the different magnetic resistances of the sheet metal and the composite material in the axial direction, the detent torques of the rotor are reduced. Due to the increased magnetic resistance in the circumferential direction in the stator core, the asymmetric forces on the rotor due to deviations from the ideal geometry are further reduced.

Further advantageous embodiments are claimed with the dependent claims and explained in more detail below.

Accordingly, it is also advantageous if the at least one stator core comprises several groups of sheet metal segments, wherein the sheet metal segments of the different groups differ in their radial extension. This makes it easy to achieve a stepped laminated core arrangement.

Thus, it is further advantageous if the sheet metal segments are designed and arranged in such a manner that a laminated core arrangement is obtained which varies in its extension in the circumferential direction in one or more steps in the radial direction.

In this context, it has proven to be advantageous that the at least one stator core, in addition to a first group of a plurality of mutually identically designed sheet metal segments extending continuously from a radially inner side (of the stator core) to a radially outer side (of the stator core), has a second group of a plurality of second sheet metal segments, wherein the second sheet metal segments have a shorter radial extension than the first sheet metal segments and are arranged towards a first circumferential side of the first group of first sheet metal segments. This further reduces the magnetic resistance.

In this respect, it is also advantageous that on a second circumferential side, facing away from the first circumferential side, of the totality of first sheet metal segments, a third group of a plurality of third sheet metal segments is arranged, wherein the third sheet metal segments have a shorter radial extension than the first sheet metal segments.

If the first sheet metal segments of the at least one stator core are designed as mutually identical parts, series production is possible in a particularly economical manner.

In this context, it is also advantageous if the second sheet metal segments and/or the third sheet metal segments are designed as mutually identical parts.

Preferably, the multiple stator cores are designed identical.

If one of the covering sections or both covering sections has/have a pole shoe contour with at least one projection projecting in the circumferential direction, a further optimized contour for reducing magnetic resistances is realized.

In this respect, it is also advantageous if the at least one projection is designed as a radially extending rib.

If the covering sections taper inwardly in the radial direction, the wedge shape of the stator core can be easily produced.

Furthermore, it is advantageous if each stator core is provided with a stator winding, wherein this stator winding forms several axially adjacent winding loops and the respective winding loop narrows inwardly in the radial direction with respect to its circumferential side width.

In this context, it is advantageous if the stator winding extends towards the first circumferential side parallel to a (preferably flat) circumferential surface of the first covering section and/or extends towards the second circumferential side parallel to a (preferably flat) circumferential surface of the second covering section.

It is also advantageous if the covering sections are formed on their side facing the sheet metal segments (circumferential side) in a manner complementary to a contour of a laminated core arrangement formed by the sheet metal segments.

In other words, according to the disclosure, a stator for an axial flux machine is implemented with radially extending electrical sheets (sheet metal segments). The metal sheets of the stator core extend radially. The stator core is covered with an SMC material (SMC=“Soft-Magnetic Composite”) in the circumferential direction.

### BRIEF DESCRIPTION OF THE DRAWINGS

The disclosure will now be explained in more detail below with reference to various figures, in which context various exemplary embodiments are also shown.

In the figures:

FIG. 1 shows a perspective view of an axial flux machine according to the disclosure, cut in the longitudinal direction according to a first exemplary embodiment, wherein its construction can be clearly seen,

FIG. 2 shows a full perspective view of one of a plurality of stator cores, as used in the axial flux machine of FIG. 1, from its radially outer side,

FIG. 3 shows a view of the stator core from its front side,

FIG. 4 shows a perspective view of a first sheet metal segment inserted in the stator core,

FIG. 5 shows a perspective view of a first covering section inserted in the stator core and made of a soft-magnetic composite material,

FIG. 6 shows a perspective view of a partial assembly formed by the stator core and a stator winding surrounding it,

FIG. 7 shows a perspective view of a partial assembly comprising a stator core designed according to a second exemplary embodiment and a stator winding surrounding this stator core,

FIG. 8 shows a perspective view of a coil arrangement of the stator according to the second exemplary embodiment, wherein a plurality of stator cores wound with coil windings are arranged in a row in the circumferential direction, and

FIG. 9 shows a front view of the entire coil arrangement shown in FIG. 8.

### DETAILED DESCRIPTION

The figures are only schematic in nature and serve only for understanding the disclosure. The same elements are provided with the same reference signs. Furthermore, the features of the different exemplary embodiments can in principle be freely combined with one another.

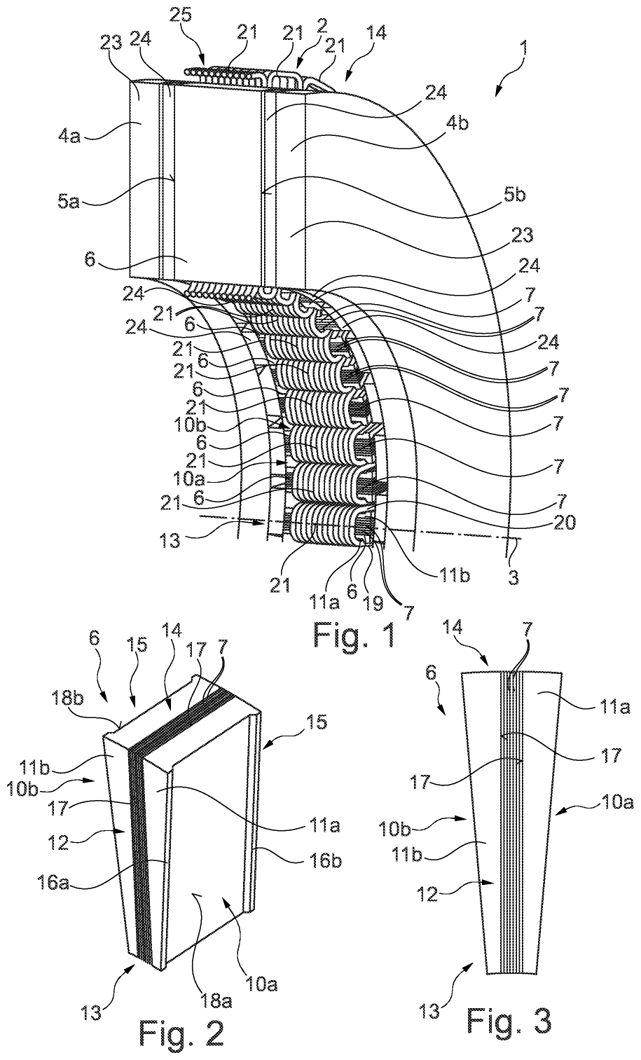

FIG. 1 shows the construction of the axial flux machine 1 according to the disclosure according to a preferred first exemplary embodiment. In its preferred application, the axial flux machine 1 is used in the drive of a motor vehicle. Accordingly, the corresponding motor vehicle is implemented either as a purely electric motor vehicle or a hybrid motor vehicle.

The directional information used below refers to a central rotational axis 3 of both rotor elements 4a, 4b of the axial flux machine 1. Accordingly, an axial direction is a direction along/parallel to the rotational axis 3, a radial direction is a direction perpendicular to the rotational axis 3, and a circumferential direction is a direction along a circular line of constant diameter extending coaxially around the rotational axis 3.

According to the construction of an axial flux machine 1, it has a substantially annular stator 2 that rotates completely in the circumferential direction (FIG. 1). It can be seen that the stator 2 has a thickness (axial extension) that is less than its height (radial thickness/height of the annulus). In further embodiments, the axial extension can also be greater/longer than the radial height of the annulus of the stator 2.

In addition to the stator 2, the two rotor elements 4a, 4b are part of the axial flux machine 1, as already mentioned. A first rotor element 4a is arranged towards a first (axial) end face 5a of the stator 2. A second (axial) end face 5b of the stator 2, facing away axially from the first end face 5a, is provided with a second rotor element 4b. The rotor elements 4a, 4b are each implemented in essentially the same manner. Both rotor elements 4a, 4b each have a disk-shaped main body 23 and a plurality of magnets 24 (permanent magnets) distributed in the circumferential direction, which magnets 24 are arranged on an axial side of the rotor elements 4a, 4b facing the stator 2. The rotor elements 4a, 4b are mounted so as to be rotatable relative to the stator 2 about the rotational axis 3 in a typical manner.

As also shown in FIG. 1, the stator 2 is equipped with a plurality of stator cores 6 distributed in a circumferential direction of the rotational axis 3. The stator cores 6 are implemented as identical parts. Each stator core 6 serves to accommodate a stator winding 21, which has several winding loops 22 arranged side by side in the axial direction (FIG. 6). The stator core 6 and stator winding 21 typically form a stator coil 25/coil arrangement. The stator coils 25 are arranged uniformly and contiguously distributed in the circumferential direction. The stator coils 25 taper in the radial direction towards their inner side. Each stator coil 25, i.e. each stator core 6 and each stator winding 21, thus has a wedge-shaped extension as seen along its radial extension, reducing in the circumferential direction.

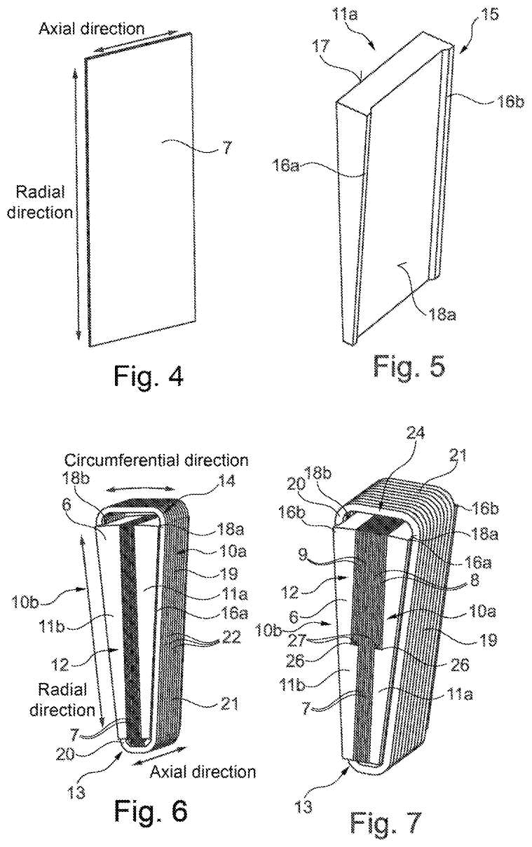

In an overall consideration of FIGS. 1 to 3, it can also be seen that according to the disclosure each stator core 6 has several first sheet metal segments 7 aligned/extending in the radial direction of the rotational axis 3. Each first sheet metal segment 7 extends along the entire radial length of the stator cores 6 or directly forms the radial ends of the stator core 6. In FIGS. 4 and 7, a first sheet metal segment 7 is shown as an example of the further first sheet metal segments 7. The first sheet metal segment 7 is designed to be rectangular in shape and has a greater extension in the radial direction than in the axial direction (preferably from an outer diameter of 200 mm), wherein this is not obligatory, however. Several first sheet metal segments 7 are stacked on top of one another in the circumferential direction to form a laminated core and are each insulated from one another in a typical manner by means of an intermediate insulation layer, which is not shown further here for the sake of clarity.

The first sheet metal segments 7 are implemented as identical parts. In this first embodiment, the first sheet metal segments 7 form a laminated core arrangement 12 with a constant thickness over the entire radial height of the stator core 6 (extension in the circumferential direction).

In addition to the first group of first sheet metal segments 7, the respective stator core 6 has two wedge-shaped covering sections 11a, 11b, each made of a soft-magnetic composite material. A first covering section 11 a is applied to the first circumferential side 10a of the group of first sheet metal segments 7, while a second covering section 11b is applied to the second circumferential side 10b of the group of first sheet metal segments 7.

The two covering sections 11a, 11b are formed identically, wherein the first covering section 11a is illustrated for representational purposes in FIG. 5. Accordingly, the first covering section 11a is designed with a flat bearing surface 17 on a side abutting the first sheet metal segments 7 in the circumferential direction. Towards a side facing away from the sheet metal segments 7 of the same stator core 6 in circumferential direction (first circumferential side 10a), the first covering section 11a forms a (first) circumferential surface 18a. The circumferential surface 18a is delimited on its axial sides by one projection 16a, 16b each forming a pole shoe contour 15. The two projections 16a, 16b project in the circumferential direction. Each projection 16a, 16b forms a rib extending in the radial direction (over the entire radial height of the stator core 6).

As further shown in FIG. 6, the stator winding 21 extends with a first section 19 parallel and adjacent to the first circumferential surface 18a. With a second section 20, the stator winding 21 extends parallel and adjacent to the (second) circumferential surface 18b of the second covering section 11b.

In FIGS. 7 to 9, a further second exemplary embodiment is shown. According to the second exemplary embodiment, not only is a first group of first sheet metal segments 7 provided in the respective stator core 6, but a second group of second sheet metal segments 8 and a third group of third sheet metal segments 9 are also present. The second sheet metal segments 8 are arranged towards the first circumferential side 10a directly abutting the first sheet metal segments 7. The third sheet metal segments 9 are arranged towards the second circumferential side 10b directly abutting the first sheet metal segments 7. The second sheet metal segments 8 and third sheet metal segments 9 are identical/designed as identical parts in this embodiment.

However, the second sheet metal segments 8 and the third sheet metal segments 9 are shorter in the radial direction than the first sheet metal segments 7. The second sheet metal segments 8 and the third sheet metal segments 9 are essentially implemented as first sheet metal segments 7 halved at a radial height. Each second sheet metal segment 8 and each third sheet metal segment 9 forms the outer radial end of the stator core 6 and is open towards the radially outer side 14, respectively. The totality of the sheet metal segments 7, 8, 9 is consequently arranged to form a laminated core arrangement 12 stepped in the radial direction. In this embodiment, the laminated core arrangement 12 is single-stepped, i.e., its thickness/extension in the circumferential direction reduces at a radial height to form a step 26. However, in further embodiments, multiple steps (at different radial heights) are also provided.

The respective second and third sheet metal segments 8, 9 are covered by the covering sections 11a, 11b in the circumferential direction and towards the radially inner side 13. Thus, in the second exemplary embodiment, the covering sections 11a, 11b have a counter-step 27 designed to be complementary to the step 26.

The sheet metal segments 7, 8, 9 of the various exemplary embodiments are each made of an electrical sheet.

In other words, according to the disclosure, it is proposed that the sheets 8, 18, 19 extend radially and are covered laterally in the circumferential direction with SMC (covering sections 11a, 11b).

FIG. 2 shows a single stator tooth 6 without a winding. The stator tooth 6 comprises a central region consisting of iron sheets 7 stacked in the circumferential direction, wherein the individual sheet layers 7 are electrically insulated from one another. The individual sheets 7 each extend approximately in the radial and axial direction (forming a corresponding surface which is approximately perpendicular to the circumferential direction).

In the circumferential direction, the stacked sheets 7 are enclosed or covered by a material with good magnetic conductivity but poor electrical conductivity (e.g. SMC =Soft-Magnetic Composite). These material sections Ila, 11b are shown as wedge-shaped parts which rest against the stack of sheets 7, 12 on both sides in the circumferential direction and are fixed to the sheets 7, 12, for example.

FIG. 3 shows the same construction, but in a plan view from the axial direction instead of a 3D view. FIG. 4 shows a single sheet 7 in a 3D view along with the orientation of the sheets 7 in the stator core 6.

FIG. 5 shows a side part 11 a made of material with good magnetic conductivity but poor electrical conductivity (e.g. SMC=Soft-Magnetic Compound). The side parts 11a, 11b have contours 16a, 16b, 15 at the ends in the axial direction for forming pole shoes. The region 18a, 18b for receiving the winding 21 for the stator tooth 6 is located between the two contours 16a, 16b for the pole shoes. The side parts 11a, 11b can also be composed of several individual parts (e.g. by dividing them perpendicularly to the axial direction so that the parts can be joined by moving them in the axial direction), wherein this is not shown separately here for the sake of clarity.

FIG. 6 shows a single stator tooth 6 supplemented by an electrical winding 21. A single-tooth winding 21 is shown here, but other winding forms are also possible. The sheets 7 in the center of the stator tooth 6 have a constant stack height over the entire radial height of the tooth 6.

FIG. 7 also shows a stator tooth 6 with a single-tooth winding 21. In contrast to FIG. 6, the central laminated core 12 has different stack heights at different radial heights (in this case, two different stack heights). Of course, given higher production expenditure, more steps 26 of the stack height are also possible. The different stack heights allow for an improved magnetic flux in the axial direction due to the higher proportion of electrical sheet in the overall tooth 6.

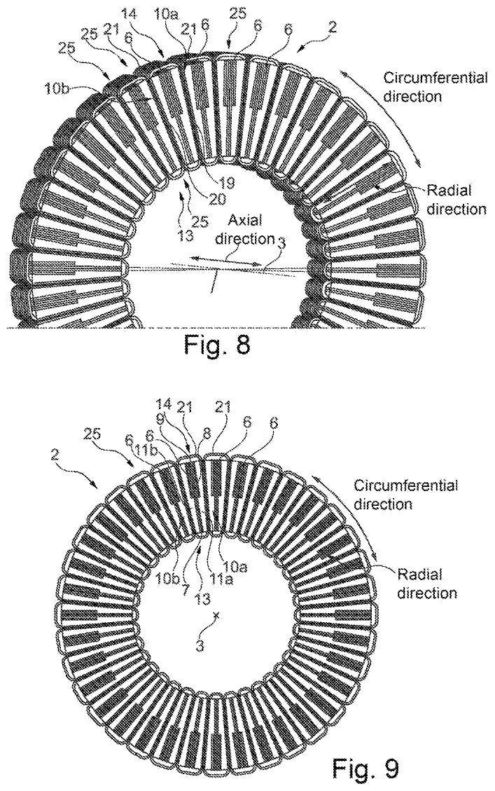

FIG. 8 shows a 3D view in which several stator teeth 6 are joined together to form a complete stator 2. The individual stator teeth 6 are arranged in a ring shape in the circumferential direction around the rotational axis 3 of the rotor 4a, 4b.

FIG. 9 shows the same construction of FIG. 8 in a plan view in the direction of the rotational axis 3. Shown here are stator teeth 6 with two different stack heights of sheets 7, 8, 9 at different radial heights of the stator 2. A connection of the windings 21 to different phases is not shown here.

In FIG. 1, the stator 2 is supplemented with a right and a left rotor 4a, 4b. Magnets 24 arranged on the surface of the back iron are visible in section. A mechanical support for the stator teeth 6 (e.g. by means of plastic socketing), the bearings of the rotors 4a, 4b and the output shaft are not shown.

### LIST OF REFERENCE SIGNS

1 Axial flux machine

2 Stator

3 Rotational axis

4a First rotor element

4b Second rotor element

5a First end face

5b Second end face

6 Stator core

7 First sheet metal segment

8 Second sheet metal segment

9 Third sheet metal segment

10a First circumferential side

10b Second circumferential side

11a First covering section

11b Second covering section

12 Laminated core arrangement

13 Inner side

14 Outer side

15 Pole shoe contour

16a First projection

16b Second projection

17 Bearing surface

18a First circumferential surface

18b Second circumferential surface

19 First section

20 Second section

21 Stator winding

22 Winding loop

23 Main body

24 Magnet

25 Stator coil

26 Step

27 Counter-step

1. An axial flux machine comprising an annular stator and two rotor elements which are mounted so as to be rotatable relative to the stator about a rotational axis, wherein a first rotor element of the two rotor elements is arranged axially adjacent to a first end face of the stator and a second rotor element of the two rotor elements is arranged axially adjacent to a second end face of the stator, and wherein the stator has a plurality of stator cores that are distributed in a circumferential direction of a circular line extending about the rotational axis, wherein at least one stator core has a plurality of radially extending sheet metal segments that are stacked on top of one another in the circumferential direction and are of plate-like design, wherein all of the sheet metal segments are surrounded on two circumferential sides, that face away from one another in the circumferential direction, by a covering section made of a soft-magnetic composite material.

2. The axial flux machine according to claim 1, wherein the at least one stator core has a plurality of groups of sheet metal segments formed from the radially extending sheet metal segments, wherein the radially extending sheet metal segments of different groups differ in their radial extension.

3. The axial flux machine according to claim 1, wherein the radially extending sheet metal segments are designed and arranged in such a manner that a laminated core arrangement is obtained which varies in its extension in the circumferential direction in one or more steps in a radial direction.

4. The axial flux machine according to claim 2, wherein the at least one stator core, in addition to a first group of the plurality of groups of sheet metal segments that are mutually identically designed and extends continuously from a radially inner side to a radially outer side, has a second group of plurality of groups of sheet metal segments, wherein the second group of sheet metal segments have a shorter radial extension than the first group of sheet metal segments and are arranged towards a first circumferential side of the first group of sheet metal segments.

5. The axial flux machine according to claim 4, wherein on a second circumferential side, facing away from the first circumferential side, of the first group of sheet metal segments, a third group of the plurality of groups of sheet metal segments is arranged in addition to the second group, wherein the third group of sheet metal segments has a shorter radial extension than the first group of sheet metal segments.

6. The axial flux machine according to claim 1, wherein the covering section has a pole shoe contour with at least one projection projecting in the circumferential direction.

7. The axial flux machine according to claim 6, wherein the at least one projection is designed as a radially extending rib.

8. The axial flux machine according to claim 7, wherein the covering section tapers inwardly in radial direction.

9. The axial flux machine according to claim 1, wherein the covering section is formed on a side facing the sheet metal segments in a manner complementary to a contour of a laminated core arrangement formed by the sheet metal segments.

10. An axial flux machine comprising:
an annular stator having a plurality of stator cores distributed in a circumferential direction about a rotational axis, wherein at least one stator core of the plurality of stator cores includes radially extending sheet metal plates that are stacked on top of one another in the circumferential direction;
first and second rotor elements mounted so as to be rotatable relative to the stator about the rotational axis, wherein the first rotor element is arranged axially adjacent to a first end face of the stator and the second rotor element is arranged axially adjacent to a second end face of the stator; and
a first cover section covering a first circumferential side of the radially extending sheet metal plates and a second cover section covering a second circumferential side of the radially extending sheet metal plates, wherein the first and the second cover sections extend from a radially inner side of the at least one stator core to a radially outer side of the at least one stator core.

11. The axial flux machine according to claim 10, wherein the first and second cover sections are made of a soft-magnetic composite material.

12. The axial flux machine according to claim 10, wherein the first and the second cover sections each include:
a flat bearing surface on a side abutting the radially extending sheet metal plates in the circumferential direction;
a first circumferential surface opposite the flat bearing surface on the side facing away from the radially extending sheet metal plates;
first and second projections that project in the circumferential direction from axial sides of the first circumferential surface, wherein the projections form a rib extending in a radial direction over an entire radial height of the stator core.
